(19) United States
(12) Patent Application Publication
(10) Pub. No.: US 2024/0217478 A1
(43) Pub. Date: Jul. 4, 2024

(54) Vehicle Security Bar

(71) Applicant: Mario Ulysses Grassano, JR., Burbank, CA (US)

(72) Inventor: Mario Ulysses Grassano, JR., Burbank, CA (US)

(21) Appl. No.: 18/217,615

(22) Filed: Jul. 3, 2023

Related U.S. Application Data
(60) Provisional application No. 63/358,029, filed on Dec. 30, 2022.

(51) Int. Cl. B60R 25/01

(52) U.S. Cl. CPC B60R 25/01

(57) ABSTRACT

The invention is an anti-theft device for 4-door automobiles which prevents an unauthorized user from being able to open the automobile's doors. It's composed of a security bar that attaches to the outside of an automobile's doors. The security bar slides inside a latch systems and can be secured by using a standard padlock or combination lock that is secured through an eyelet on the security bar, then through to a hole on the latch. When secured and locked in place, the security bar prevents the door from being opened.

### BACKGROUND OF THE INVENTION

Field of the Invention: The invention is an anti-theft device for 4-door automobiles which prevents unauthorized users from physically being able to open a vehicle's door(s). Automobile theft is prevalent in America, today, through a variety of electronic methods, including door-prying devices that allow entry into automobiles. Theft can be minimized by the installation of a security bar which prevents the doors, of a 4-door automobile, from being opened.

### BRIEF SUMMARY OF THE INVENTION

The invention is an anti-theft device for automobiles. It prevents unauthorized users from being able to open the doors of a 4-door automobile. It's composed of a security bar, attached to the outside of an automobile's doors, that slides inside a latch system and is secured with a padlock or combination lock. This device can be installed on both the driver and passenger-side doors.

### BRIEF DESCRIPTION OF THE SEVERAL VIEWS OF THE DRAWING(S)

The structure of the invention is described, below, with reference to the accompanying drawings, in which the following:

FIG. 1 is a partial view of the driver's side of a typical 4-door automobile with the security bar, an anti-theft device secured with a common combination lock (the lock which is not part of the invention). See FIG. 2 for an exploded view, description, and additional reference points near or on 1.A, 1.B, and 3. The invention's reference points on FIG. 1 are the three latches at 1.A, 1.B, and 1.C; the eyelet of the security bar at 2; and the security bar, itself, at 3. The combination lock at 4 is, solely, for informational purposes. One can use any common lock they desire that fits into the security bar's eyelet and latch's hole.

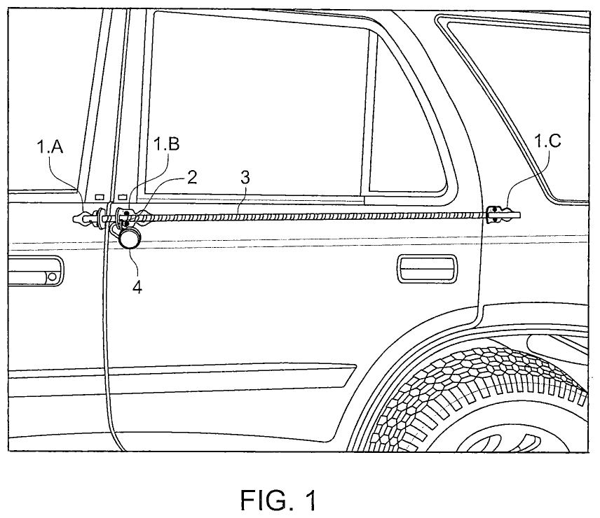

FIG. 2 is a partial section—an exploded view of the invention on front driver's door area. The combination lock, for example, at 4 attaches through the eyelet at 2 and through to the hole at 5 of latch 1.B. At 6 is a knurled or chiseled area, as in this drawing, which functions as placement-catch for latch 1.B when one needs to remove the security bar in order to open the front door without having to remove the entire security bar.

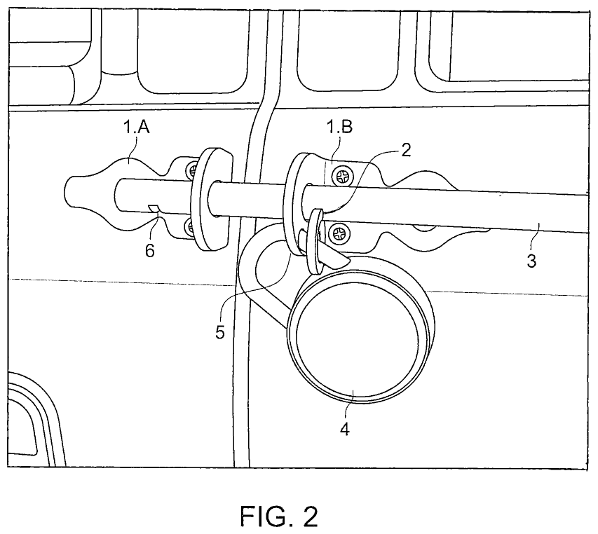

FIG. 3 is a partial section—an exploded view of the invention on the rear driver's door area depicting latch 1.C.

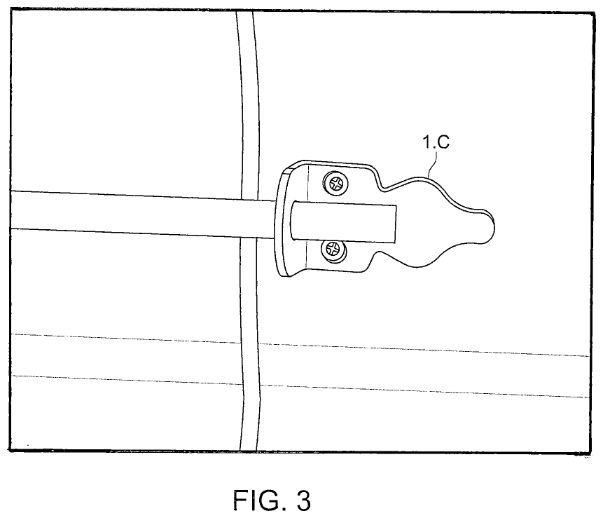

### DETAILED DESCRIPTION OF THE INVENTION

The invention is an anti-theft device for automobiles. It prevents unauthorized users from being able to open the doors of 4-door vehicle models. This device can be installed on both the driver and passenger-side doors. Below, I will discuss one side of the identical system. The device is composed of a bar, with a small metal eyelet at the end, that slides into the holes of 3 latches, then a padlock or combination-lock secures the bar to a hole on the latch via an eyelet on the security bar. The latches are attached adjacent to the front and rear door seams and next to the outside of the rear-door seam.

The bar and latches are preferably made of a metal material, but they can also be made from wood or plastic. The latches can either be welded into place, attached with metal sheet screws or machine-screws and nuts, and/or glued into place with epoxy. The bar may be provided with a nubbed, knurled, or chiseled-end to prevent the bar from sliding out, completely, when sliding the bar to open the front door.

Automobile theft is a common criminal act, and it's difficult to prevent. Door-prying devices, that allow entry for coat hangers, are a popular method for gaining entry into automobiles, today. Also, thieves are using high-tech electronic devices to compromise security-alarms and gain unauthorized entry.

The purpose of the invention is, therefore, to provide a device that physically prevents unauthorized access and the opening of 4-door automobile doors by a means of which the doors are latched and padlocked shut from the outside of the vehicle in order to provide for a secondary lock system without affecting the normal operation of the vehicle manufacturer's door-lock cylinder device. It's additional purpose is to provide such an anti-theft device in a form which is economical to produce and simple to install.

1. The invention is an anti-theft device that prevents the unauthorized opening of a 4-door automobile's doors, that's composed of a security bar that slides inside a latch system and which is secured by any standard padlock via the security bar's eyelet and a hole on the latch.
